(19) United States
(12) Patent Application Publication
(10) Pub. No.: US 2014/0330607 A1
(43) Pub. Date: Nov. 6, 2014

(54) PERSONALIZATION OF NOTIFICATIONS ON MOBILE DEVICES FOR ENTERPRISE SYSTEMS

(71) Applicant: Zhong Zhang, Los Altos, CA (US)

(72) Inventor: Zhong Zhang, Los Altos, CA (US)

(21) Appl. No.: 13/887,158

(22) Filed: May 3, 2013

(51) Int. Cl. G06Q 10/10

(52) U.S. Cl. CPC G06Q 10/1093
USPC 705/7.18

(57) ABSTRACT

Personalization of notifications can be provided. Personalized notification settings defining operation of a personalized notification (e.g., what business event or events trigger the notification, number of occurrences of the notification, frequency of the occurrences, audio indicators, and/or visual indicators) can be entered at a mobile device and stored at a server environment. The server environment can monitor business events and send the personalized notifications when a match is detected between a monitored business event and the personalized notification settings.

### BACKGROUND

With the ever increasing use of mobile devices in the enterprise world, and with the need for pervasive data connectivity to such mobile devices, it is important to have the ability to communicate business critical information from enterprise systems to mobile devices.

Notification systems provide one way of alerting end users of important information. Typically, notification solutions provide a number of pre-defined options. Such options include the ability to turn notifications on or off, the ability to turn sounds on or off, and whether to show notifications on the lock screen.

However, existing notification systems on mobile devices provide limited functionality. For example, existing notification systems may have limited customization options and may not provide real-time alerting of events that are occurring within the enterprise. In addition, existing notification systems may not provide the ability to customize alerts based on the type of business activity that generated the alert.

Therefore, there exists ample opportunity for improvement in technologies related to managing notifications.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

For example, personalized notification settings defining operation of a personalized notification (e.g., what business event or events trigger the notification, number of occurrences of the notification, frequency of the occurrences, audio indicators, and/or visual indicators) can be entered at a mobile device and stored at a server environment. The server environment can monitor business events send personalized notifications (e.g., to the mobile device) when there is a match (e.g., when a business event setting matches a monitored business event).

As another example, a method can be provided for managing personalized notifications. The method can be implemented, at least in part, by a mobile computing device. The method comprises displaying, by the mobile computing device, a user interface to a user for creating personalized notification settings, receiving the personalized notification settings from the user defining a personalized notification, and sending the personalized notification settings to a server environment. The personalized notification settings can be stored by the server environment and used by the server environment when sending the personalized notification to the mobile computing device. Receiving the personalized notification settings can comprise receiving a selection of a business event, where the business event is associated with enterprise software, receiving a selection of a number of occurrences of the personalized notification, and/or receiving a selection of a frequency with which the personalized notification will be sent.

As yet another example, a method implemented, at least in part, by a server environment, can be provided. The method comprises receiving personalized notification settings defining a personalized notification, where the personalized notification settings comprise an indication of a user-selected business event, storing the personalized notification settings, monitoring a business event occurring at the server environment, and when the monitoring indicates that the business event occurring at the server environment matches the personalized notification settings, sending the personalized notification to the mobile computing device according to the personalized notification settings.

As described herein, a variety of other features and advantages can be incorporated into the technologies as desired.

### BRIEF DESCRIPTION OF THE DRAWINGS

FIG. 1 is a diagram depicting an example computing environment for managing personalized notifications.

FIG. 2 is a flowchart of an example method for managing personalized notifications, including displaying a user interface for creating personalized notification settings.

FIG. 3 is a flowchart of an example method for managing personalized notifications, including receiving and storing personalized notification settings.

FIG. 4 is a diagram depicting an example user interface for entering personalized notification settings.

FIG. 5 is a diagram of an example computing system in which some described embodiments can be implemented.

FIG. 6 is an example cloud computing environment that can be used in conjunction with the technologies described herein.

### DETAILED DESCRIPTION

### EXAMPLE 1

### Overview

The following description is directed to techniques and solutions for managing personalized notifications. For example, personalized notification settings can be created by users of computing devices (e.g., mobile computing devices, such as mobile phones). The personalized notification settings can be sent to a server environment for storage (e.g., persisted at the server environment). The server environment can monitor business events. When a monitored business event matches the personalized notification settings (e.g., when the settings indicate a business event that matches the monitored business event), the server environment can send (e.g., push) the personalized notification (e.g., a personalized alert) to the mobile computing device (e.g., send a user-configured number of occurrences of the personalized notification at a user-configured frequency). When the personalized notification is received by the mobile computing device, it can be presented to the user (e.g., presented according to the personalized notification settings, which can include display of business event information that triggered the notification, audio and/or visual indicators, etc.).

The ability to provide real-time notifications (e.g., real-time alerts) is particularly important when dealing with enterprise software systems and business critical information. It is also important to provide the ability to personalize and customize such notifications. For example, a user, such as a manager, can receive personalized notifications for those business events that the manager is interested in (e.g., purchase approval events), with notification settings configured by the manager (e.g., number of instances of the notification, audio and/or visual indicators, etc.). For example, the user can personalize the settings according to the importance or criticality of the information (e.g., set a higher number of occurrences and frequency, and/or certain audio and visual indicators, for more important business events and a lower number of occurrences and frequency, and/or certain audio and visual indicators, for less important business events).

For example, a user of a mobile computing device can create personalized notification settings defining one or more personalized notifications (e.g., a separate set of personalized notification settings defining each corresponding personalized notification). A particular set of personalized notification settings (defining a particular personalized notification) can be associated with (e.g., triggered by) a specific business event. The business event can be specified, for example, by a particular business object, workflow, approval process, etc. The business event can also be specified by particular change to, or context associated with, a particular business object, workflow, approval process, etc. (e.g., creation of a particular business object, changes in state to a particular business object, etc.).

For example, consider a user that is a sales manager of a business. The user may be interested in tracking the progress of sales activity for a specific customer. Such a user can enter personalized notification settings for notifying the user when a sales-related business event occurs that is associated with the particular customer (e.g., by specifying a “Sales Opportunity” business event for the specific customer). Then, when business events are monitored (e.g., by an enterprise sales software system or customer relationship management software system), and a match is detected (e.g., a “Sales Opportunity” business event related to the particular customer is detected), a personalized notification can be sent to the user. The user can further personalize the notification by configuring additional personalized notification settings. For example, the user could specify that the personalized notification applies only to certain types of changes to the “Sales Opportunity” business event (e.g., only sales for the customer that are entering a “To be Closed” stage).

Personalized notification settings can be created by users and sent to a server environment for storage and processing. For example, business users can create personalized notification settings associated with their mobile devices (e.g., mobile phones) and store the settings at a server environment associated with the business. The server environment can then monitor business events occurring at the business or associated with the business. When the server environment detects a match between one of the monitored business events and a set of personalized notification settings, then the server environment can send a corresponding personalized notification (as defined by the personalized notification settings) to the user's mobile device to be presented to the user.

By storing personalized notification settings at the server environment, the server environment can monitor business events for any number of users (e.g., employees and other users associated with the business). The server environment can deliver personalized notifications to the users when monitored events match the settings. For example, the server environment can filter the business events and send notifications only when a match is detected (e.g., a match based on the type of business event, changes to the business event such as a change in the stage of a business object, changes to a workflow, etc.).

### EXAMPLE 2

### Server Environment

In any of the examples herein, an environment can be provided for managing personalized notifications. For example the environment can include a server environment operated by a business or organization. The server environment can provide personalized notification services to client devices (e.g., operated by users or employees of the business or organization). For example, users can create personalized notification settings using mobile computing devices. The personalized notification settings can be sent to the server environment and stored. The server environment can monitor business events and send notifications to the users, by way of their mobile computing devices, based on the stored personalized notification settings.

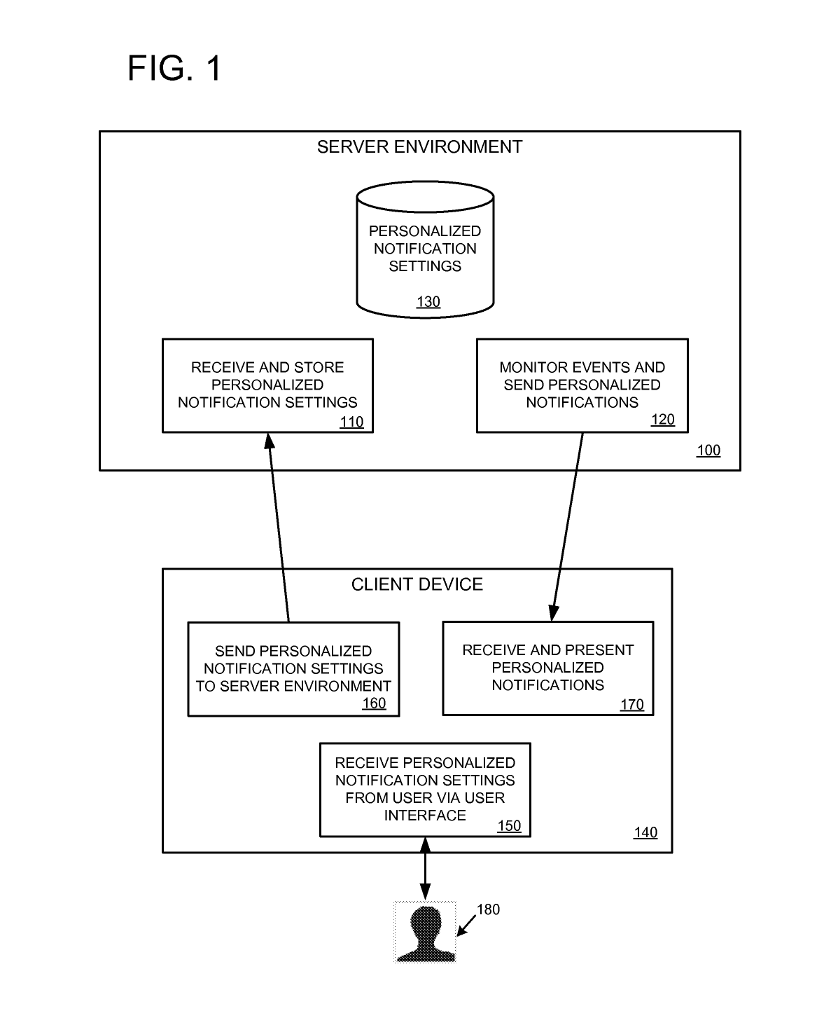

FIG. 1 is a diagram depicting an example environment for managing personalized notifications. The environment comprises a server environment 100. The server environment 100 can comprise various types of computing devices, such as computer servers, web servers, data storage systems, cloud computing resources, networking resources, etc. The server environment 100 operates enterprise software (e.g., accounting systems, human resources systems, customer relationship management (CRM) systems, enterprise resource planning (ERP) systems, and/or other enterprise software systems). The server environment 100 also provides personalized notification services to any number of client devices and associated users, such as client device 140 and associated user 180.

The client device 140 can be any type of client computing device. For example, the client device 140 can be a mobile computing device (e.g., a mobile phone or tablet computing device). As depicted at 150, the client device 140 can display a user interface to the user 180 of the client device 140 for receiving personalized notification settings from the user 180. As depicted at 160, the client device 140 can send the personalized notification settings to the server environment 100. As depicted at 170, the client device 140 can receive personalized notifications from the server environment 100 and present (e.g., using audio, visual, and/or haptic indications) the personalized notifications.

The server environment 100 can receive and store personalized notification settings from the client device 140, as depicted at 110. For example, the server environment 100 can store the personalized notification settings in a data store 130 (e.g., a database). The server environment 100 can provide an application programming interface (API) for receiving the personalized notification settings from the client device 140, and from any number of other client devices. In this way, the server environment 100 can provide a standardized interface for receiving personalized notification settings from various types of user devices (e.g., mobile phones, tablet computers, and/or other types of computing devices).

The server environment 100 can monitor business events (e.g., in real-time as the business events occur within the server environment 100) and send personalized notifications to the client device 140, as depicted at 120. For example, the server environment 100 can monitor business events that are occurring in enterprise software (e.g., accounting systems, human resources systems, customer relationship management systems, enterprise resource planning systems, and/or other enterprise software systems). The server environment 100 can determine whether a monitored business event matches personalized notification settings (e.g., by accessing the personalized notification settings data store 130). If a match is detected (e.g., if the business event associated with the personalized notification settings matches the monitored business event), then a personalized notification can be sent to the client device 140. The personalized notification can include indications of the business event that occurred (e.g., the identity of a particular business objected and/or a change to a particular business object), indications of audio settings, indications of visual settings, indications of haptic settings, and/or other types of indications.

### EXAMPLE 3

### Methods for Managing Personalized Notifications

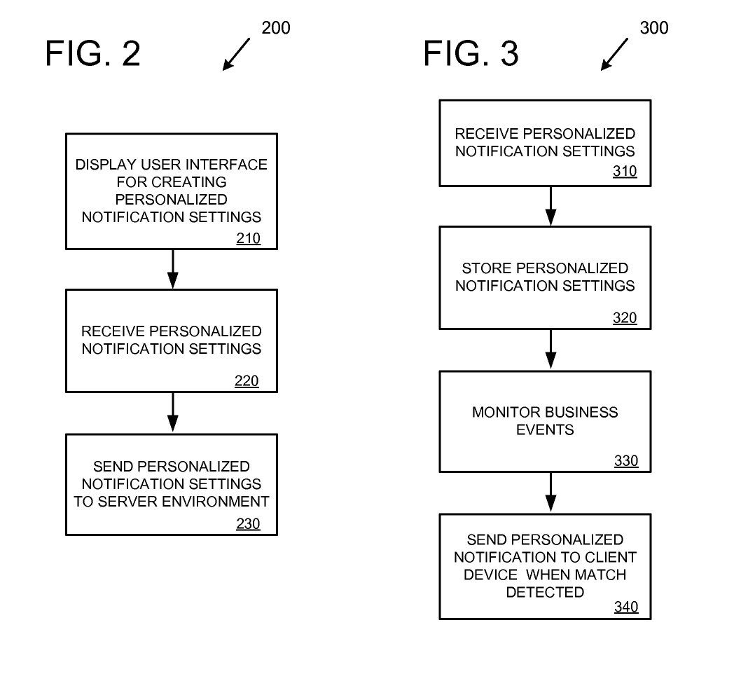

In any of the examples herein, methods can be provided for managing personalized notifications. FIG. 2 is a flowchart of an example method 200 for managing personalized notifications. The example method 200 can be performed, at least in part, by a computing device (e.g., by the computing device 140 depicted in FIG. 1).

At 210, a user interface (e.g., a graphical user interface) is displayed to a user for creating personalized notification settings. For example, the user interface can be displayed on a mobile computing device, such as a mobile phone, to the user of the mobile computing device. The user interface can comprise various user interface elements (e.g., data entry fields, buttons, checkboxes, drop-down lists, and/or other user interface elements for user-input of personalized notification settings).

At 220, personalized notification settings are received from the user via the displayed user interface. The personalized notification settings define a personalized notification, including how the personalized notification operates (e.g., when the personalized notification will be sent and how the user will be alerted, which can included repetitive notifications, audio indications, visual indications, haptic indications, etc.).

The personalized notification settings can comprise an indication of a business event that is associated with enterprise software. For example, one or more user interface elements can be displayed for receiving a selection of the business event (e.g., from a number of possible business events).

The personalized notification settings can also comprise an indication of how many occurrences (instances) of the personalized notification to send (e.g., to send to the user's mobile computing device and presented to the user). For example, a user interface element can be displayed for receiving a selection of a numerical value (e.g., a user-entered value or a value selected from a list of available values).

The personalized notification settings can also comprise an indication of the frequency with which the personalized notification will be sent. For example, if there will be more than one occurrence of the personalized notification, then a user-selected frequency can be received via the user interface (e.g., selected from a number of available frequencies, such as once every 5 minutes, once per hour, etc.). By allowing the user to select the number of occurrences and/or the frequency of the personalized notification, the user can personalize the notification to the user's particular needs. For example, if the user is creating personalized notification settings for a particularly important event (e.g., to be notified when in important pending sale is closed), the user can increase the number of occurrences and/or the frequency to ensure that the user does not miss or overlook the notification. For example, the user could create personalized notification settings to be notified 10 times (10 occurrences), once every 30 minutes. In some implementations, such repetitive notifications can be stopped (even if all occurrences have not yet been sent) once the user acknowledges the notification (e.g., once the user selects or taps on the notification on the user's device, or otherwise acknowledges the notification).

The personalized notification settings can also comprise audio settings. For example, user-selected audio settings can be received via the user interface that control audio content to be played when the personalized notification is presented to the user. The audio settings can comprise, for example, an indication of audio content (e.g., a particular sound). For example, different sounds can be used to indicate notifications related to different types of business events and/or different levels of importance.

The personalized notification settings can also comprise visual settings. For example, user-selected visual settings can be received via the user interface that control visual content to be displayed when the personalized notification is presented to the user. The visual settings can comprise, for example, an indication of visual content (e.g., a particular graphic, icon, color, etc.). For example, different visual indications (e.g., different icons) can be used to indicate notifications related to different types of business events and/or different levels of importance.

The personalized notification settings can also comprise haptic settings. For example, user-selected haptic settings can be received via the user interface that control haptic feedback when the personalized notification is presented to the user. The haptic settings can comprise, for example, whether to include vibration, the type and/or pattern of vibration, etc.

The personalized notification settings can also comprise location-based settings. For example, user-selected location-based settings can be received via the user interface that control how personalized notifications are sent based on the location of the user's mobile device. The user's mobile device can send location information (e.g., current location) to a server environment (e.g., when the user's mobile device moves to a new location). For example, the location-based settings can comprise a setting to enable sending a notification when the user travels to a location near the offices of a particular business account.

At 230, the personalized notification settings are sent to a server environment for storage. The personalized notification settings are used by the server environment when sending the personalized notification to the mobile computing device. For example, the server environment can monitor business events, determine whether there are matches between the monitored business events and the personalized notification settings (e.g., based on a user-selected business event), and send the personalized notification to the client device when a match is detected.

When the client device (e.g., mobile computing device) receives the personalized notification, it can be presented to the user according to the personalized notification settings (e.g., indication of business event that triggered the notification, number of occurrences, frequency, audio indicators, visual indicators, haptic indicators, etc.). In some implementations, the user can select the notification and perform a related action. For example, selecting the notification for a purchase approval business event can display an application where the user can approve the purchase (e.g., approve a purchase order for a new hire).

FIG. 3 is a flowchart of an example method 300 for managing personalized notifications. The example method 300 can be performed, at least in part, by a server environment (e.g., by the server environment 100 depicted in FIG. 1).

At 310, personalized notification settings are received (e.g., from a mobile computing device). The personalized notification settings define a personalized notification (e.g., define which business events will trigger the personalized notification and define notification settings, such as number of instances of the notification, frequency, visual and audio indications, etc., that will be used when the personalized notification is sent to the client device and presented to the user). For example, the personalized notification settings can comprise an indication of a user-selected business event (e.g., comprising a user-selected business object, workflow, process, etc.).

At 320, the personalized notification settings are stored. For example, the personalized notification settings can be stored in a data store (e.g., database) associated with the server environment.

At 330, business events occurring at the server environment are monitored. For example, the business events can comprise business events occurring within the server environment, business events occurring between the server environment and third parties, and/or business events related to the server environment. The business events can include, for example, events related to various enterprise software systems (e.g., accounting systems, human resources systems, customer relationship management systems, and/or other enterprise software systems). An example of a specific business event is a purchase approval business event that is related to an approval process workflow of a business.

At 340, when the monitoring (at 330) indicates that there is a match between a monitored business event and the business event specified by the personalized notification settings, the personalized notification is sent (e.g., to the mobile computing device) for presentation. The personalized notification is sent with the settings specified by the personalized notification settings (e.g., number of occurrences, frequency, audio indicators, visual indicators, etc.).

### EXAMPLE 4

### Creating Personalized Notification Settings

In any of the examples herein, personalized notification settings can be created by a user using a user interface (e.g., a graphical user interface) of a computing device (e.g., a mobile computing device, such as a mobile phone). The user interface can present various user interface controls allowing the user to configure the personalized notification settings. Once the personalized notification settings have been entered, they can be sent to a server environment for storage and monitoring.

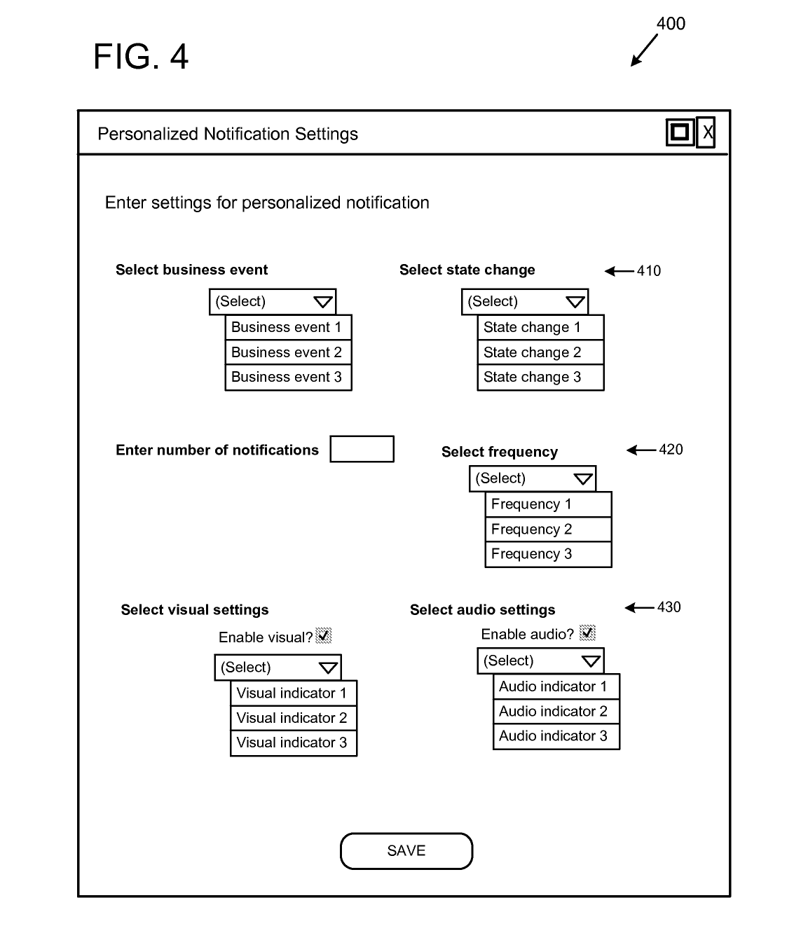

FIG. 4 is a diagram depicting an example user interface 400 for entering personalized notification settings. For example, the user interface 400 can be displayed by the computing device 140 depicted in FIG. 1.

The example user interface 400 includes user interface elements for entering business event and related state change personalized notification settings 410. Using the user interface elements at 410, a user can select a particular business event (e.g., selected from a list of available business events, as depicted). For example, “Business event 1” could be a “Sales Opportunity” business event, “Business event 2” could be a “Sales Account” business event, and “Business event 3” could be a “Purchase Approval” business event.

In some implementations, the user can also select a particular state change related to the selected business event (e.g., selected from a list of available state changes, as depicted). The state change can indicate a change from a particular state or states, to a particular state or states, and/or between particular states or groups of states. As an example, if the “Sales Opportunity” business event is selected, then the state change list can include a “Deal in Process” state change (e.g., indicating that there is a pending deal for the sales opportunity), a “To be Closed” state change (e.g., indicating that the sales opportunity has entered the “To be Closed” stage), and a “Closed” state change (e.g., indicating that the sales opportunity deal has closed).

The example user interface 400 includes user interface elements for entering a number of notifications and a frequency for the notifications 420. Using the user interface elements at 420, a user can select how many occurrences of the personalized notification are to be sent. For example, the user can enter a particular value (e.g., 5 or 10) or the user can select from a list of per-determined values (e.g., per-determined values such as 1, 2, 5, 10, 20, etc.). The user can also select the frequency with which the notifications are to be sent. For example, if the user has selected more than one occurrence of the personalized notification, then the frequency can be selected from a list of available frequencies (e.g., every 5 minutes, every 30 minutes, hourly, etc.). As an example, if the user selects 10 occurrences with an 30 minute frequency, then then personalized notification can be delivered to the user's mobile device and presented to the user once every 30 minutes until the personalized notification has been sent 10 times (over a five hour period).

The example user interface 400 includes user interface elements for entering visual and audio settings 430. Using the user interface elements at 430, a user can select whether visual settings are enabled and which visual settings to use. For example, the visual settings can include selection of a particular graphic or icon to use when the personalized notification is displayed on the user's device. Using the user interface elements at 430, the user can also select whether audio settings are enabled and which audio settings to use. For example, the audio settings can include selection of a particular sound to play when the personalized notification is displayed on the user's device.

Once the user has configured the personalized notification settings using the example user interface 400, the user can save the settings. Saving the settings can send the settings to a server environment for storage and later processing (e.g., processing to monitor for business events that match the settings and then send personalized notifications according to the settings).

The example user interface 400 can be used by the user to create personalized notification settings for any number of personalized notifications. For example, the user can create personalized notification settings (a set of personalized notification settings comprising selections from the depicted user interface elements 410-430) for a particular business event and state change, and save the personalized notification settings. The user can then create personalized notification settings (another set of personalized notification settings) for a different business event. The user can repeat this process as desired to create personalized notification settings for each business event (e.g., business object, workflow, process, etc.) for which the user wishes to receive a personalized notification.

### EXAMPLE 5

### Computing Systems

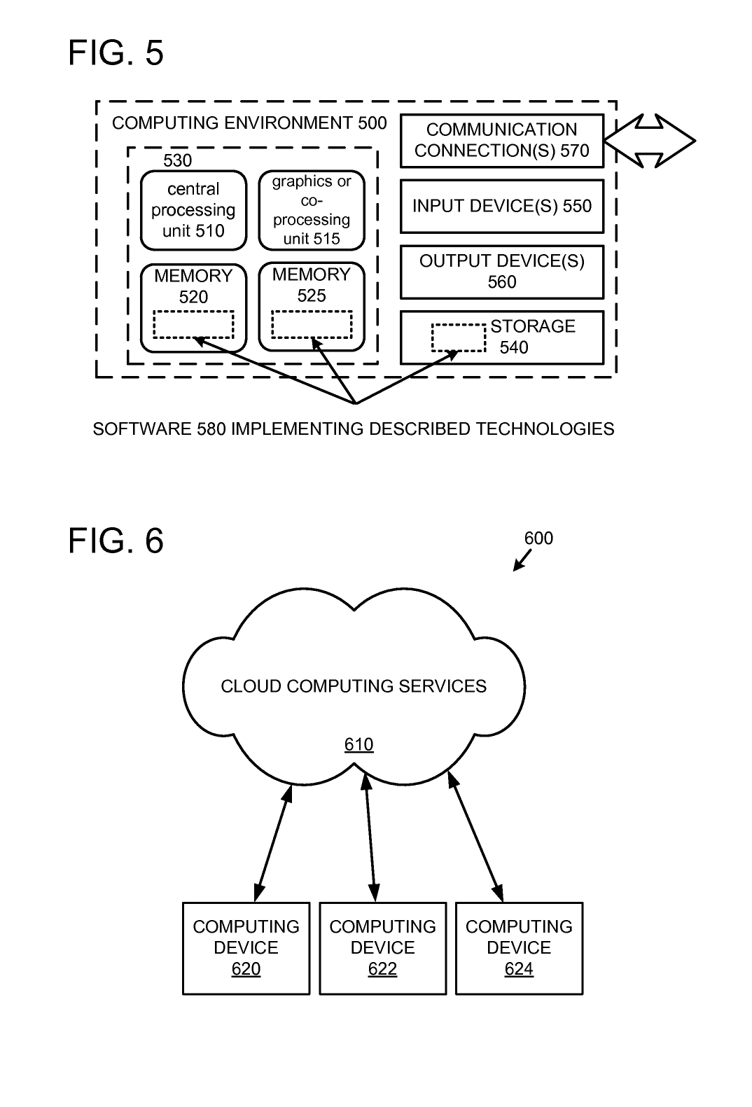

FIG. 5 depicts a generalized example of a suitable computing system 500 in which the described innovations may be implemented. The computing system 500 is not intended to suggest any limitation as to scope of use or functionality, as the innovations may be implemented in diverse general-purpose or special-purpose computing systems.

With reference to FIG. 5, the computing system 500 includes one or more processing units 510, 515 and memory 520, 525. In FIG. 5, this basic configuration 530 is included within a dashed line. The processing units 510, 515 execute computer-executable instructions. A processing unit can be a general-purpose central processing unit (CPU), processor in an application-specific integrated circuit (ASIC) or any other type of processor. In a multi-processing system, multiple processing units execute computer-executable instructions to increase processing power. For example, FIG. 5 shows a central processing unit 510 as well as a graphics processing unit or co-processing unit 515. The tangible memory 520, 525 may be volatile memory (e.g., registers, cache, RAM), non-volatile memory (e.g., ROM, EEPROM, flash memory, etc.), or some combination of the two, accessible by the processing unit(s). The memory 520, 525 stores software 580 implementing one or more innovations described herein, in the form of computer-executable instructions suitable for execution by the processing unit(s).

A computing system may have additional features. For example, the computing system 500 includes storage 540, one or more input devices 550, one or more output devices 560, and one or more communication connections 570. An interconnection mechanism (not shown) such as a bus, controller, or network interconnects the components of the computing system 500. Typically, operating system software (not shown) provides an operating environment for other software executing in the computing system 500, and coordinates activities of the components of the computing system 500.

The tangible storage 540 may be removable or non-removable, and includes magnetic disks, magnetic tapes or cassettes, CD-ROMs, DVDs, or any other medium which can be used to store information in a non-transitory way and which can be accessed within the computing system 500. The storage 540 stores instructions for the software 580 implementing one or more innovations described herein.

The input device(s) 550 may be a touch input device such as a keyboard, mouse, pen, or trackball, a voice input device, a scanning device, or another device that provides input to the computing system 500. For video encoding, the input device(s) 550 may be a camera, video card, TV tuner card, or similar device that accepts video input in analog or digital form, or a CD-ROM or CD-RW that reads video samples into the computing system 500. The output device(s) 560 may be a display, printer, speaker, CD-writer, or another device that provides output from the computing system 500.

The communication connection(s) 570 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

### EXAMPLE 6

### Cloud Computing Environment

FIG. 6 depicts an example cloud computing environment 600 in which the described technologies can be implemented. The cloud computing environment 600 comprises cloud computing services 610. The cloud computing services 610 can comprise various types of cloud computing resources, such as computer servers, data storage repositories, networking resources, etc. The cloud computing services 610 can be centrally located (e.g., provided by a data center of a business or organization) or distributed (e.g., provided by various computing resources located at different locations, such as different data centers and/or located in different cities or countries).

The cloud computing services 610 are utilized by various types of computing devices (e.g., client computing devices), such as computing devices 620, 622, and 624. For example, the computing devices (e.g., 620, 622, and 624) can be computers (e.g., desktop or laptop computers), mobile devices (e.g., tablet computers or smart phones), or other types of computing devices. For example, the computing devices (e.g., 620, 622, and 624) can utilize the cloud computing services 610 to perform computing operators (e.g., data processing, data storage, and the like).

### EXAMPLE 7

### Implementations

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media and executed on a computing device (e.g., any available computing device, including smart phones or other mobile devices that include computing hardware). Computer-readable storage media are any available tangible media that can be accessed within a computing environment (e.g., one or more optical media discs such as DVD or CD, volatile memory components (such as DRAM or SRAM), or nonvolatile memory components (such as flash memory or hard drives)). By way of example and with reference to FIG. 5, computer-readable storage media include memory 520 and 525, and storage 540. The term computer-readable storage media does not include communication connections (e.g., 570) such as signals and carrier waves.

Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present or problems be solved.

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the following claims. I therefore claim as my invention all that comes within the scope and spirit of the claims.

I claim:

1. A method, implemented at least in part by a mobile computing device, for managing personalized notifications, the method comprising:
by the mobile computing device:
displaying, to a user, a user interface for creating personalized notification settings;
receiving, from the user via the user interface, the personalized notification settings defining a personalized notification, wherein receiving the personalized notification settings comprises:
receiving a selection of a business event, wherein the business event is associated with enterprise software;
receiving a selection of a number of occurrences of the personalized notification; and
receiving a selection of a frequency with which the personalized notification will be sent; and
sending, by the mobile computing device to a server environment, the personalized notification settings, wherein the personalized notification settings are stored by the server environment, and wherein the personalized notification settings are used by the server environment when sending the personalized notification to the mobile computing device.

2. The method of claim 1, wherein receiving the personalized notification settings further comprises:
receiving a selection of an audio setting comprising an indication of audio content to be played when the personalized notification is presented at the mobile computing device.

3. The method of claim 1, wherein receiving the personalized notification settings further comprises:
receiving a selection of a visual setting comprising an indication of visual content to be displayed when the personalized notification is presented at the mobile computing device.

4. The method of claim 1, wherein receiving the personalized notification settings further comprises:
receiving a selection of a location-based setting to use for the personalized notification.

5. The method of claim 1, wherein receiving the selection of the business event comprises receiving a selection of a business object.

6. The method of claim 5, wherein receiving the selection of the business event further comprises receiving a selection of a status change related to the selected business object.

7. The method of claim 1, further comprising, for one or more additional personalized notifications:
receiving, from the user via the user interface, additional personalized notification settings defining an additional personalized notification; and
sending, by the mobile computing device to the server environment, the additional personalized notification settings, wherein the additional personalized notification settings are stored by the server environment, and wherein the additional personalized notification settings are used by the server environment when sending the additional personalized notification to the mobile computing device.

8. The method of claim 1, further comprising:
receiving, by the mobile computing device from the server environment, the personalized notification, wherein the personalized notification is received by the mobile computing device upon occurrence of the business event at the server environment; and
presenting, by the mobile computing device to the user, the personalized notification.

9. The method of claim 1, wherein the personalized notification settings are not stored at the mobile computing device.

10. A method, implemented at least in part by a server environment, for managing personalized notifications, the method comprising:
by the server environment:
receiving, from a mobile computing device, personalized notification settings defining a personalized notification, wherein the personalized notification settings comprise an indication of a user-selected business event;
storing the personalized notification settings;
monitoring a business event occurring at the server environment; and
when the monitoring indicates that the business event occurring at the server environment matches the personalized notification settings, sending the personalized notification to the mobile computing device according to the personalized notification settings.

11. The method of claim 10, wherein the personalized notification settings comprise a user-selected number of occurrences of the personalized notification and a user-selected frequency with which the personalized notification will be sent, the method further comprising:
sending a number of instances of the personalized notification, corresponding to the user-selected number of occurrences, to the mobile computing device; and
sending the number of instances of the personalized notification at the user-selected frequency.

12. The method of claim 10, wherein monitoring the business event comprises:
determining whether the business event occurring at the server environment matches the user-selected business event indicated by the personalized notification settings.

13. The method of claim 10, wherein determining whether the business event occurring at the server environment matches the user-selected business event indicated by the personalized notification settings comprises determining whether a state change to the business event occurring at the server environment matches a user-selected state change to the user-selected business object indicated by the personalized notification settings.

14. The method of claim 10, wherein the personalized notification settings comprise a user-selected audio setting, and wherein the personalized notification sent to the mobile computing device comprises an indication of the user-selected audio setting.

15. The method of claim 10, wherein the personalized notification settings comprise a user-selected video setting, and wherein the personalized notification sent to the mobile computing device comprises an indication of the user-selected video setting.

16. The method of claim 10, wherein the server environment sends the personalized notification to the mobile computing device in real-time as the business event is monitored.

17. The method of claim 10, wherein the personalized notification comprises:
an indication of the business event occurring at the server environment;
an indication of a user-selected audio setting; and
an indication of a user-selected video setting.

18. A server environment comprising:
one or more computer servers; and
one or more databases;
the server environment configured to perform operations for managing personalized notifications, the operations comprising:
receiving, from a mobile computing device, personalized notification settings defining a personalized notification, wherein the personalized notification settings comprise an indication of a user-selected business event;
storing the personalized notification settings;
monitoring a business event occurring at the server environment; and
when the monitoring indicates that the business event occurring at the server environment matches the personalized notification settings, sending the personalized notification to the mobile computing device according to the personalized notification settings, wherein the personalized notification is sent to the mobile computing device in real-time as the business event occurring at the server environment is monitored.

19. The server environment of claim 18, wherein the personalized notification settings comprise a user-selected number of occurrences of the personalized notification and a user-selected frequency with which the personalized notification will be sent, the method further comprising:
sending a number of instances of the personalized notification, corresponding to the user-selected number of occurrences, to the mobile computing device; and
sending the number of instances of the personalized notification at the user-selected frequency.

20. The server environment of claim 18, wherein monitoring the business event comprises:
determining whether the business event occurring at the server environment matches the user-selected business event indicated by the personalized notification settings.
